(19) United States
(12) Patent Application Publication
(10) Pub. No.: US 2023/0383108 A1
(43) Pub. Date: Nov. 30, 2023

(54) PROCESS FOR PRODUCTION OF CELLULOSE PARTICLES

(71) Applicants: National Research Council of Canada, Ottawa (CA); DOMTAR Inc., Montreal (CA)

(72) Inventors: Hongbo LI, Laval (CA); Minh Tan TON-THAT, Montréal (CA); Éric PATENAUDE, St-Jean-sur-Richelieu (CA); Karen STOEFFLER, Montréal (CA); Harshad PANDE, Montréal (CA); Shabnam SANAEI, Montréal (CA); Bruno MARCOCCIA, Montréal (CA)

(21) Appl. No.: 18/032,605

(22) PCT Filed: Oct. 15, 2021
(86) PCT No.: PCT/CA2021/051450

§ 371 Date: Apr. 19, 2023

Related U.S. Application Data
(60) Provisional application No. 63/094,456, filed on Oct. 21, 2020.

(51) Int. Cl. C08L 23/12; C08J 5/18; C08K 3/22; D21B 1/32; D21H 21/08; D21H 17/07; D21H 17/06; D21H 17/53; D21H 17/09

(52) U.S. Cl. CPC C08L 23/12; C08J 5/18; C08K 3/22; D21B 1/32; D21H 21/08; D21H 17/07; D21H 17/06; D21H 17/53; D21H 17/09; C08J 2301/02; C08L 2205/16; C08K 2003/2206

(57) ABSTRACT

Cellulose particles treated with a bio-based surfactant can be compounded into a polymer composite having improved mechanical properties, such as tensile strength and/or tensile modulus. Treatment can be integrated into an industrial scale continuous cellulose particle production process, and the process provides one or more of reduced environmental impact, reduced energy consumption, reduced chemical consumption, reduced water consumption, reduced processing/operational cost, reduced capital investment, increased output, improved fiber dispersion in the polymer matrix and improved thermal degradation properties of the composite.

### CROSS-REFERENCE TO RELATED APPLICATIONS

This application claims the benefit of U.S. Provisional patent application U.S. Ser. No. 63/094,456 filed Oct. 21, 2020, the entire contents of which is herein incorporated by reference.

### FIELD

This application relates to the production of cellulose particles, in particular to a process for treating cellulose particles to make the particles more suitable as fillers in polymer matrices.

### BACKGROUND

Wood particles, such as wood flour, sawdust, shaving, etc., are used as fillers in polymer products due to the low cost, low density and renewability of the wood particles. Plant fibers, such as flax, hemp, kenaf, etc., and wood fibers, such as Kraft pulp, mechanical pulp, thermo-mechanical pulp, etc., have high specific tensile strength and modulus, low density and high aspect ratio (fiber length:fiber diameter), thus exhibiting excellent reinforcing properties for polymer matrices. For successful application, the fibers must be well dispersed in, and have good interaction with, the polymer matrices. One significant challenge for plant and wood fiber pulp is the strong hydrogen bonding between the fiber fibrils, making the fiber bundles extremely difficult to disperse in the hydrophobic polymer matrix. Thus, obtained composites have a very coarse morphology with a significant portion of the fiber agglomerated in a size of up to a few hundred micrometers or even millimeters. This significantly affects the processing of the materials, such as by injection molding and extrusion, as well as the mechanical performance and surface finish of the materials. The large fiber agglomerates block the flow in small cavities in the injection mold or extrusion die, and also act as stress concentrators thereby initiating early defects when the composite is submitted to a stress. In addition, the agglomerated fibers can also affect surface finish, a property that is desirable for many applications. When the polymer matrix is more hydrophobic, such as in the case of polyolefins, this issue becomes more serious. In the case of Kraft pulp, Kraft pulp is finally dried (90-95% water removal) in order to significantly reduce storage space and shipping cost. Hydrogen bonding between the fibers in the sheet, especially after drying, becomes extremely strong. It is therefore a challenge to disperse the pulp fibers uniformly in a polymer matrix without damaging the fibers.

To improve fiber dispersion in thermoplastic matrices, weakening of hydrogen bonds between the fibers is required. Conventional methods for improving the fiber dispersion include: aggressive screw configurations to generate high shear in the flow in order to separate the fiber during compounding; pretreatment of fibers using reactive chemicals such as thermoset oligomers (e.g. formaldehyde-based oligomers and isocyanate), maleic anhydride based oligomers, etc., to create one or more functional groups on the fiber surface to promote certain interactions with the polymer matrix, thus improving the affinity with the matrix or even forming chemical bonds with the matrix; a combination of mat forming and chemical treatment; and, pretreatment of fibers using surfactants, especially for hygiene paper. In the pretreatment of fibers using surfactants, the type of surfactant used permits maintaining very high moisture content in the hygiene paper in order to accelerate the paper dispersion in water media. Such pretreatment methods using surfactants have also been used for the treatment of cellulose nanocrystals (CNC) using a batch process.

The aforementioned conventional methods cannot solve all the problems simultaneously (i.e. satisfactory fiber dispersion and good mechanical performance for obtained composites, cost-efficiency, environmental performance). The first methodology requires a very aggressive screw which can thermally and mechanically degrade fibers and the matrix due to generation of local shear stresses thereby inducing local heat and also fiber length attrition, thus reducing composite performance. The second methodology is not efficient for polyolefin matrices, the most popular used polymers in the market, because polyolefins are very inert and hydrophobic. Maleic anhydride based compatibilizers cannot overcome strong hydrogen bonds between the fibers. Formaldehyde-based oligomers and isocyanate are harmful chemicals to human health. Furthermore, the addition of reactive chemicals requires additional steps for mixing with fibers, even requiring the use of organic solvents. The third methodology is not very cost-effective due to the requirement of additional steps for mat making and thermoset blending and curing. The use of thermosets can also have a negative impact on the biodegradability of the cellulose fibers and it is not environmentally friendly. In addition, the use of thermosets requires necessary equipment for those steps, thus increasing capital investment. The fourth methodology uses a very large amount of surfactant to prepare hygiene papers and retain a large quantity of water in the fibers. Thus, the method is not cost-effective nor suitable for production of polymer composites in which the fibers are required to be dried prior to blending with the polymer matrix. When the surfactant methodology is used to treat CNC, the method was performed in a batch process on laboratory scale, requiring a large quantity of water to dissolve the surfactant and disperse the nanoparticles that take place in a subsequent step after the production of CNC. The cost of recovering the surfactant in the surfactant-based method is very high.

There remains a need for an industrially applicable process for making cellulose particles (e.g. fibers including microfibers, nanofilaments, nanocrystals, etc., as well as agriculture shives, hurds, straw, sawdust, wood flours, wood shavings, etc.) that are suitable for polymer matrices, especially thermoplastic polymer matrices, whereby the process has one or more of reduced environmental impact, energy consumption, chemical consumption, water consumptions, processing cost and capital investment.

### SUMMARY

A continuous process for treating cellulose particles comprises: continuously forming a cellulose pulp from a raw cellulose source in a pulp mill; and, either (a) mixing a bio-based surfactant with the pulp as the pulp is formed followed by continuously forming a surfactant-containing cellulose particle sheet from the pulp in the pulp mill, or (b) continuously forming a cellulose particle sheet from the pulp in the pulp mill followed by soaking the cellulose particle sheet as the sheet is formed with an aqueous solution of a bio-based surfactant to continuously form a surfactant-containing cellulose particle sheet, the surfactant-containing cellulose particle sheet comprising 30-70 wt % of water, based on total weight of the surfactant-containing cellulose particle sheet.

Treated cellulose particles are produced by the process described above.

A polymer composite comprises treated cellulose particles dispersed in a polymer matrix, the treated cellulose particles produced by the process described above.

The process is industrially applicable and the cellulose particles are suitable for polymer matrices, especially thermoplastic polymer matrices. The process provides one or more of, preferably all of, reduced environmental impact, reduced energy consumption, reduced chemical consumption, reduced water consumption, reduced processing/operational cost, reduced capital investment, increased output, improved fiber dispersion in the polymer matrix, improved mechanical properties of the polymer composite and improved thermal degradation properties of the polymer composite.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a flow chart of a wet lay process for making sheets of pulp fibers in a pulp mill.

FIG. 2 depicts a flow chart for producing cellulose particle sheets in a semi-continuous process that simulates the continuous wet lay process of FIG. 1.

FIG. 3 depicts a flow chart showing a first embodiment of how the semi-continuous process of FIG. 2 can be adapted to permit treating cellulose particles with a bio-based surfactant.

FIG. 4 depicts a flow chart showing a second embodiment of how the semi-continuous process of FIG. 2 can be adapted to permit treating cellulose particles with a bio-based surfactant.

FIG. 5A, FIG. 5B and FIG. 5C are optical microscope images of: a polypropylene composite containing untreated cellulose fibers (FIG. 5A); a polypropylene composite containing treated cellulose fibers having 0.75 wt % Arquad™ 2HT-75 surfactant incorporated therein (FIG. 5B); and, a polypropylene composite containing treated cellulose fibers having 3.50 wt % Arquad™ 2HT-75 surfactant incorporated therein (FIG. 5C).

FIG. 6A and FIG. 6B are optical microscope images of: a polypropylene composite containing untreated cellulose fibers (FIG. 6A); and, a polypropylene composite containing treated cellulose fibers having 3.5 wt % sodium stearate surfactant incorporated therein (FIG. 6B).

FIG. 7A and FIG. 7B are optical microscope images of: a polypropylene composite containing cellulose fibers treated with sodium stearate (FIG. 7A); and, a polypropylene composite containing cellulose fibers treated with a diluted Masterbatch (MB) of sodium stearate (FIG. 7B).

FIG. 8A, FIG. 8B, FIG. 8C and FIG. 8D are optical microscope images of: a polypropylene composite containing untreated cellulose fibers compound with a Coperion™ extruder (FIG. 8A); a polypropylene composite containing untreated cellulose fibers compounded with a Leistritz™ extruder (FIG. 8B); a polypropylene composite containing treated cellulose fibers having 3.5 wt % Arquad™ 2HT-75 surfactant incorporated therein and compounded with a Coperion™ extruder (FIG. 8C); and, a polypropylene composite containing treated cellulose fibers having 3.5 wt % Argued™ 2HT-75 surfactant incorporated therein and compounded with a Leistritz™ extruder (FIG. 8D);

### DETAILED DESCRIPTION

Cellulose particles are treated with a bio-based surfactant to produce treated cellulose particles. Treatment may be accomplished in a continuous process or a batch process, but the treatment is particularly useful in a continuous process whereby treatment of the cellulose particles with the bio-based surfactant during continuous processing of cellulose particles into a vendible product, e.g. dried powders or dried sheets of the treated cellulose particles.

A bio-based surfactant is a surfactant intentionally made from substances derived from living or once-living organisms. Preferably, the bio-based surfactant is biodegradable. The nature of the surfactant can play an important role in improving the mechanical properties of polymeric composites incorporating the treated cellulose particles. In some embodiments, the bio-based surfactant comprises a by-product from a pulp and paper mill, for example tall oils or rosin acids. In some embodiments, the bio-based surfactant comprises a fatty acid. Treatment efficiency strongly depends on hydrocarbon content of the surfactant. Thus, the bio-based surfactant preferably comprises an alkyl chain having at least 12 carbon atoms, more preferably at least 14 carbon atoms, yet more preferably 16-20 carbon atoms. The bio-based surfactant preferably comprises a cationic surfactant, an anionic surfactant or any mixture thereof. The bio-based surfactant preferably comprises di(hydrogenated tallow)dimethylammonium chloride, di(hydrogenated tallow)dimethylammonium bromide, sodium stearate, hexadecyltrimethylammonium chloride, hexadecyltrimethylammonium bromide or any mixture thereof.

The amount of bio-based surfactant used to treat the cellulose particles can also play an important role in improving the mechanical properties of polymeric composites incorporating the treated cellulose particles. The bio-based surfactant is preferably mixed with the cellulose particles in an amount of 5 wt % or less, based on weight of the cellulose particles, more preferably 3 wt % or less or 2 wt % or less or 1 wt % or less. Preferably, 0.1 wt % or more, based on weight of the cellulose particles, more preferably 0.5 wt % or more, of the bio-based surfactant is used to treat the cellulose particles.

Cellulose particles are preferably particles that are suitable for being treated with the bio-based surfactant and then dispersed in polymer matrices, especially thermoplastic polymer matrices, for the production of composites. Example of cellulose particles include fibers (e.g. microfibers), nanofilaments, nanocrystals and the like. The cellulose particles may be provided from any suitable source, for example, pulp mills, waste treatment plants, vegetable processing plants, biorefineries, extraction plants using solvent extraction processes (e.g. Alcel extraction and the like), steam explosion processes, etc. In a preferred embodiment, the cellulose particles are produced in a wood pulping process. Wood pulping processes include, for example, Kraft pulping, soda pulping, sulfite pulping, mechanical pulping, thermomechanical pulping and the like.

Treatment of the cellulose particles with the bio-based surfactant is accomplished by contacting the cellulose particles with the bio-based surfactant at a suitable temperature for a suitable amount of time. The bio-based surfactant is preferably dissolved in an aqueous medium (e.g. water) prior to being added to the cellulose particles. Concentration of the bio-based surfactant in the aqueous medium depends on the type of bio-based surfactant and the solubility of the bio-based surfactant in the aqueous medium, but is typically 1-10 wt %, based on total weight of the aqueous medium. Suitable temperatures for conducting the treatment are generally in a range of from ambient temperature to 60° C., for example 10° C. to 60° C. Suitable treatment times are generally in a range of from 1 minute to 1 hour, preferably 1-10 minutes. A minimum treatment of 1 minute is preferred for the bio-based surfactant to have sufficient time to penetrate inside particle bundles to ensure that the treatment efficiency is adequate.

Contacting the bio-based surfactant with the cellulose particles may be accomplished by mixing the bio-based surfactant with a suspension of the cellulose particles in a liquid medium, preferably an aqueous medium such as water. After mixing the bio-based surfactant with the cellulose particles, the treated cellulose particles may be formed into a surfactant-containing cellulose particle sheet.

Alternatively, the cellulose particles may be formed into a sheet prior to treatment with the bio-based surfactant, and the cellulose particle sheet soaked with the bio-based surfactant, preferably with an aqueous solution of the bio-based surfactant, to form a surfactant-containing cellulose particle sheet. Soaking the cellulose particle sheet may comprise spraying the cellulose particle sheet with the bio-based surfactant with a sprayer.

The surfactant-containing cellulose particle sheet may be pressed to reduce water content in and remove excess surfactant from the surfactant-containing cellulose particle sheet. Drying the surfactant-containing cellulose particle sheet after compressing may be performed to further reduce the water content of the surfactant-containing cellulose particle sheet. The surfactant-containing cellulose particle sheets may be cut into smaller sheets or chopped into pellets. Prior to being used to make polymer composites, treated cellulose particles of sufficiently small size are separated from the surfactant-containing cellulose particle sheet.

Polymer composites comprise treated cellulose particles dispersed in a polymer matrix. The composite may be produced by compounding the treated cellulose particles with a polymer or mixture of polymers using standard compounding techniques. Due to the presence of the bio-based surfactant, the treated cellulose particles can be substantially homogeneously dispersed in the polymer matrix with lower required shear intensity required and higher output, leading to less fiber damage, less thermal degradation of the fiber and polymer matrix, and lower operation cost.

Polymers for the production of polymer composites include, for example, thermoplastic, elastomeric or thermoset polymers. Thermoplastic polymers are preferred. Polyolefins are more preferred. Some examples of polymers include petroleum-based polymers such as polyethylenes, polypropylenes, polyvinylchloride, polyamides, polyethylene terephthalates, polyvinylchlorides, polybutenes, polybutadienes, polybutylene succinates, etc., and bio-based polymers such as polylactides, polybutylene succinates, polyalkanoates, thermoplastic starches, bio-based polyamides, and the like. The polymer makes up the balance of the polymer composite after accounting for the treated cellulose particles and any other additives included in the composite.

The polymer composites preferably comprise 10-70 wt % of the treated cellulose particles, based on total weight of the composite. More preferably, the treated cellulose particles are present in the composite in an amount of 20-40 wt %.

Other additives that facilitate compounding or that impart beneficial properties to the resulting polymer composite may be included. Some examples of other additives include processing aids, fillers (e.g. inorganic fillers), compatibilizers, plasticizers, antioxidants, ultraviolet (UV) stabilizers, colorants, nucleating agents, chain extenders, impact modifiers or any mixtures thereof. The other additives are preferably present in the polymer composite in a total amount of 0.1-25 wt %, based on total weight of the composite.

The nature of the fillers can also play an important role in improving the mechanical properties of polymeric composites incorporating the treated cellulose particles. In one embodiment, use of an alkaline metal oxide (e.g. MgO, CaO), or a compound (e.g. Mg(OH)₂, Ca(OH)₂, MgCO₃ or CaCO₃) that can produce an alkaline metal oxide, together with the treated cellulose particles provides a synergistic improvement in mechanical properties (e.g. tensile strength and/or tensile modulus) of the polymer composite. Mixtures of such fillers may be used. CaO is particularly preferred. In one embodiment, dispersing the alkaline metal oxide into the polymer matrix in an amount of 5-15 wt %, based on total weight of the composite, synergistically improves tensile strength and/or tensile modulus of the polymer composite.

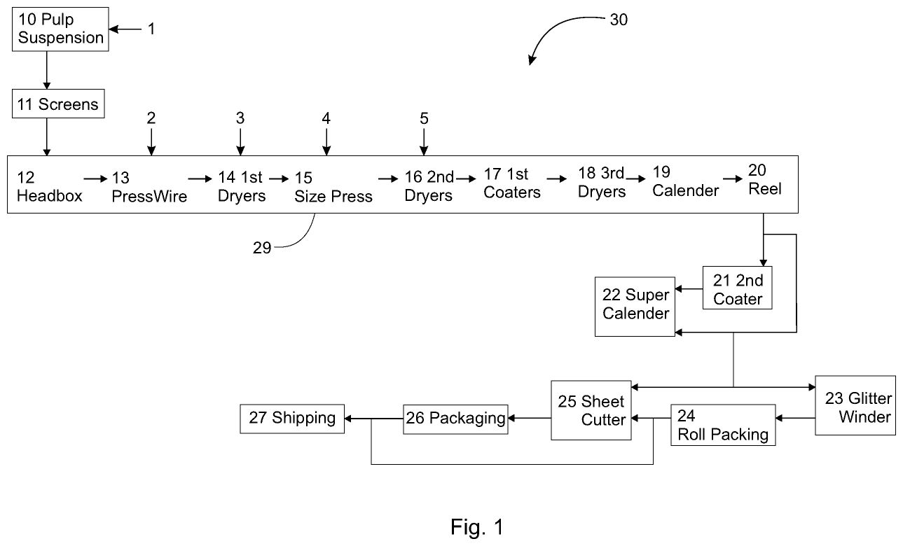

In one embodiment, a continuous treatment process of cellulose particles can be integrated into an industrial wet lay process during the production of pulp sheets in a pulp mill. FIG. 1 depicts a process flowchart of the wet lay process for pulp fibers in a pulp mill. As seen in FIG. 1, the wet lay process 30 comprises screening 11 a pulp suspension 10 to remove large objects, and passing the screened pulp suspension to a headbox 12 of a roller assembly 29 for removing water from the pulp suspension and making a sheet of the cellulose particles. The screened pulp suspension generally has a solids content of 2-6 wt %, based on total weight of the pulp suspension. The roller assembly 29 comprises a press wire 13 that receives the pulp suspension from the headbox 12 to organize the pulp suspension into a sheet-like form, which is then passed through first dryers 14 to reduce water content and through a size press 15 to both press more water out of the suspension and produce a wet pulp sheet of desired thickness. From the size press 15, the pulp sheet is passed through second dryers 16 to reduce the water content of the pulp sheet to 60-70 wt % (30-40 wt % solids), then through first coaters 17 to coat the cellulose particles with various additives, and then through third dryers 18 to remove enough water so that the pulp sheet can be turned into a dry sheet of cellulose particles by a calender 19. The sheet of cellulose particles is reeled 20 and passed to a second coater 21 if further coating is desired, or passed directly to a super calender 22 that receives the sheet from either the second coater 21 or directly from the reel 20. The sheet of cellulose particles from the reel second coater 21 or super calender 22 is wound at a glitter winder 23, rolled with a roll packer 24 and/or cut at a sheet cutter 25 followed by packaging 26, if desired, and shipping 27. The bio-based surfactant may be dispersed 1 into the pulp suspension prior to sheet forming; or, sprayed 2 continuously onto wet sheets during sheet forming, sprayed 3 or 5 during drying, or sprayed 4 at the size press 15. Spraying 4 the bio-based surfactant on the sheet at the size press 15 is preferred because less surfactant is generally required. Any bio-based surfactant pressed out from the pulp sheet by compression can be collected and recycled for further treatment to achieve zero waste/chemical disposal. In both cases, the bio-based surfactant can be effectively and homogeneously dispersed into the pulp sheets to prevent formation of strong hydrogen bonds between the fibers in the sheets after drying.

Thus, the addition of bio-based surfactant can be directly integrated into existing pulping processes, whereby: no additional equipment and operating steps are required for the fiber treatment; no chemical losses are expected thus achieving zero waste; additives can be recycled/reused; by-products of the pulp processing (e.g. fatty acids) can be used as the surfactant for the treatment; treated fibers require lower shear stresses in an extruder during compounding with a polymer while being finely dispersible in the polymer thus conversing fiber length, increasing the composite compound production throughput and improving the composite mechanical performance; and, the treated fibers are easily dispersible in hydrophobic polymer matrices, including thermoplastics such as polyolefins. Further, selection of an appropriate type and quantity of surfactant ensures effectiveness in composite production while minimizing the material cost. Finally, cellulose fiber treatment with the surfactant and an alkaline metal oxide compounded into the polymer composite provides a synergistic effect, significantly improving mechanical properties (tensile strength and/or tensile modulus) of the composites, while reducing the amount of polymer required for the composite.

### EXAMPLES

Because of the high cost of testing processes in a real continuous wet lay process at a pulp mill, the viability of the present cellulose particle treatment process was instead validated using a semi-continuous sheet-forming process. Such semi-continuous sheet-forming processes are commonly used to validate the ability of producing wet paper sheets in continuous production lines.

A semi-continuous process 40 for making cellulose particle sheets is illustrated in FIG. 2. The process comprises dispersing 41 pulp in water with a mechanical mixer to form a pulp suspension, followed by spraying 42 the pulp suspension onto a rotating screen. The pulp suspension forms into a sheet, whereupon the sheet is removed from the screen and compressed to remove water 43.

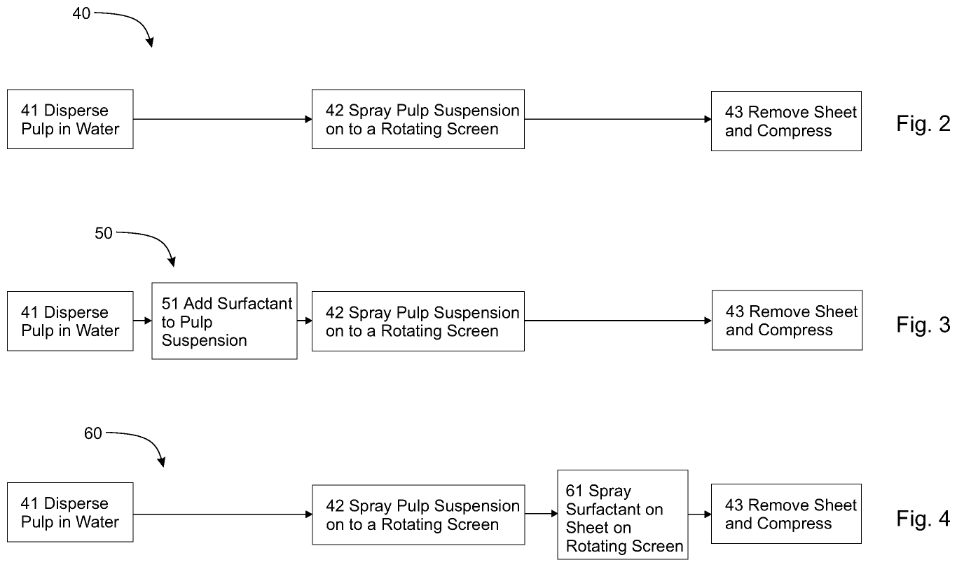

The semi-continuous process of FIG. 2 can be adapted in two way to permit treating the cellulose particles with the bio-based surfactant, as shown in FIG. 3 and FIG. 4. As seen in FIG. 3, in a first process 50 for treating the cellulose particles, the bio-based surfactant can be added 51 to the pulp suspension and mixed with a mechanical mixer prior to spraying 42 the pulp suspension onto the rotating screen. As seen in FIG. 4, in a second process 60 for treating the cellulose particles, the bio-based surfactant can be sprayed 61 on to the cellulose particle sheet while the sheet is on the rotating screen, and prior to removing the sheet from the screen 43. In some cases, the bio-based surfactant can be both added to the pulp suspension and sprayed on the sheet on the rotating screen.

### Materials and Equipment

The following materials were used in the Examples.

### Sheet Former and Sheet Press

Noram™ Dynamic Sheet Former from Noram.
Noram™ Sheet Press from Noram.

### Chopper:

Model G28L1 from Pierret.

### Compounders:

34 mm Twin screw extruder from Lestritz™
34 mm Twin screw extruder from Coperion™

### Pulps:

Hardwood Kraft pulp from Domtar Inc. (>96% cellulose).
Thermomechanical pulp (TMP) fiber in dry state from Papier Masson Ltd.

### Surfactants:

TABLE 1
Surfactants

| Surfactant | Type | Alkyl Content |
|---|---|---|
| Arquad™ 2HT-75 (AQ) from Sigma-Aldrich | Cationic | High |
| Di(hydrogenated tallow)dimethylammonium chloride | | C₁₆-C₁₈ |
| Sodium stearate (SS) from Sigma-Aldrich | Anionic | High |
| | | C₁₆ |
| Tween™ 20 (Tween) from Sigma-Aldrich | Non-ionic | Very low |
| Polyoxyethylene sorbitol ester | | |
| Span™ 20 (Span) from Sigma Aldrich | Non-ionic | Average |
| Sorbitan monolaurate | | C₁₂ |
| Downy™ Fabric Softener or Downy Dilutes (Downy) | Cationic | Very low |
| from Procter & Gamble | | C₂ |
| Diethyl ester dimethyl ammonium chloride | | |
| 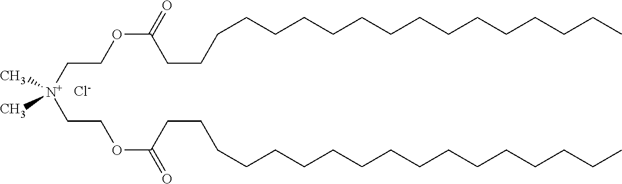 | | |
| Ultra Tide™ Detergent (Tide) from Procter & Gamble | Anionic with | |
| Linear alkyl benzene sulfonate, sodium/MEA salts; | enzymes | |
| amylase and protease | | |
| Hexadecyltrimethylammonium bromide (HTMA) from | Cationic | High |
| Sigma-Aldrich | | C₁₆-C₁₈ |

### Polymers:

Polypropylene (Pro-fax™ 6323, PP homopolymer from LyondellBasell).
Polypropylene (Pro-fax SG802N, one impact PP copolymer from LyondellBasell).
Polypropylene (Braskem FT200WV, PP homopolymer from Braskem America Inc.).

### Compatibilizer:

Maleic anhydride grafted polypropylene wax (Epolene™ E-43 from Westlake Chemical).

### Compound Processing Aid:

Blend of aliphatic carboxylic acid salts, mono and diamides (Struktol™ TPW 104 from Struktol Company of America).

### Inorganic Filler:

Calcium oxide (CaO from Fisher Scientific).

### Example 1: Comparing Surfactants

In this Example, the surfactants listed in Table 1 were examined for their efficiency at treating pulp fibers. The following treatment methods were followed, and treatment efficiency was evaluated based on the ease at which dried treated fibers could be separated.

A Kraft pulp sheet was chopped and dispersed in tap water at room temperature to to obtain a suspension containing between 5-10 wt % dried pulp. This step was performed with propeller or high-speed mixer. Surfactant was dissolved in water (1-10 wt % depending on the type of surfactant and its solubility in water) at room temperature and for 20 min then added to the pulp suspension. Surfactant content was: 0.1, 0.25, 0.5, 2 or 5 wt %, based on weight of the dried fiber. Treatment time was: 1, 5, 10, 20 or 30 minutes. Treatment temperature was room temperature or 50° C. After the treatment the fibers were centrifuged to remove water and dried at 105° C. overnight to remove moisture.

Fibers that were subjected to the same treatment process but without adding surfactant adhered very strongly and were difficult to separate after drying.

A treatment time of at least 5 minutes ensured sufficient time for the surfactant to penetrate into fiber bundles. Shorter times negatively impacted treatment efficiency.

AQ, HTMA, Tween and Downy can be used to treat fibers at room temperature with good treatment efficiency, but a temperature of 50° C. was best for ensuring treatment efficiency when using SS.

AQ (cationic), HTMA (cationic), SS (anionic) are the most efficient surfactants for fiber treatments. The pulp absorbs AQ, HTMA and SS very well. AQ, HTMA and SS are effective at low concentration, for example AQ remains efficient at a concentration of 0.1 wt %, based on weight of fiber, while HTMA and sodium SS remained efficient at a concentration of 0.25 wt %, based on weight of fiber. After water removal by drying the pulp fibers at 105° C., the fibers do not adhere together to form hard aggregates. The treated fibers are easily separated. Furthermore, there is no change in appearance of the fibers (e.g. no dark color or bad odor) after drying of the treated fibers.

The other surfactants, Span, Tide, Tween and Downy, were less efficient. Higher surfactant concentrations were needed for the treatment. For example, 5 wt % concentration was needed for Span, Tide, Tween and Downy to be effective.

Surfactant efficiency depends on specific chemistry of the surfactant regardless of whether the surfactant is cationic or anionic. The efficiency strongly depends on the hydrocarbon content in the surfactant.

Surfactant efficiency does not only depend on the chemistry of surfactant but also on treatment conditions. Some of surfactants require longer time and higher temperature for the treatment.

### Example 2: Validation of Fiber Treatment Using AQ Surfactant in Batch Mechanical Mixer

The batch process described in Example 1 was scaled up using the AQ surfactant to verify advantages of AQ-treated cellulose fibers for polymer composite applications.

A Kraft pulp sheet was chopped and dispersed in tap water with a mechanical mixer to obtain a suspension of 2 wt % dried pulp, based on weight of the suspension. AQ was dissolved in tap water at 50° C. and mixed for 30 minutes to obtain a 7.5 wt % solution of AQ in water. The Kraft pulp fibers were treated with the AQ solution by dispersing the AQ solution in water with a mechanical mixer for 20 minutes followed by adding the fiber suspension a room temperature and mixing for 10 minutes with a mechanical mixer to disperse the fibers uniformly. At the end of the treatment, the fiber suspension was centrifuged to remove as much water as possible prior to drying. Drying was performed at 105° C. to lower moisture content of the fibers to below 10 wt %. The treated fibers after drying agglomerate in loose aggregates, which were easily separated via pressing by hand.

Three batches of treated fibers were prepared having different surfactant content. For each batch, 2,000 g of dried pulp was used with sufficient AQ solution to provide the different AQ content as follows:
Batch F1A1: has 0.75 wt % AQ, based on weight of the treated fiber.
Batch F1A2: has 1.75 wt % AQ, based on weight of the treated fiber.
Batch F1A3: has 3.50 wt % AQ, based on weight of the treated fiber.

Infrared analysis (FTIR) of the AQ treated fibers showed evidence of peaks at 2918 cm⁻¹ related to CH₂ asymmetric stretching of fatty acid hydrocarbons, which demonstrates that AQ molecules are attached to the surface of the fibers.

The AQ treated Kraft pulp fibers were then compounded with polypropylene (PP) (Pro-fax™ 6323) to validate the effectiveness of the treated fibers in polymer composites in terms of mechanical properties and fiber dispersion in the PP matrix. 2 wt % of Epolene™ E43, based on weight of the composite, was used in all formulations to improve the interfacial bonding between the AQ treated fibers and the polymer matrix. Table 2 lists the composites that were formulated.

Compounding was performed using a 34 mm Lestritz twin screw extruder with the screw designed to maximize the fiber dispersion while not degrading the fiber during processing. The processing temperature was set in the range of 180-200° C. and screw speed 200-250 rpm. The extruded threads were cooled by air after exiting the die and pelletized. The pellets were collected and sealed in plastic bags to prevent moisture absorption, which were used later for inject molding into test specimens as listed in Table 2. These specimens were used for characterizing the mechanical properties and fiber dispersions by optical microscope.

TABLE 2
Composite Formulations: AQ-Treated Fibers

| | | AQ | Fiber | Epolene ™ |
|---|---|---|---|---|
| | Fiber | (wt % in | (wt % in | (wt % in |
| Sample | Type | fiber) | composite) | composite) |
| Benchmark | Chopped | | 30 | 2 |
| | Kraft fiber | | | |
| 30F1A1E | F1A1 | 0.75 | 30 | 2 |
| 30F1A2E | F1A2 | 1.50 | 30 | 2 |
| 30F1A3E | F1A3 | 3.50 | 30 | 2 |

Observations of the Benchmark sample that contained only chopped fibers showed that the chopped fibers are poorly dispersed therein, the composite having many big millimeter-sized aggregates of fibers, which are not acceptable for polymer composite applications. The big fiber aggregates will be exposed to the environment such as moisture, etc. leading to reduced long term stability of the composite. In addition, the big fiber aggregates will also negatively affect the mechanical performance and material processability in making thin walled parts.

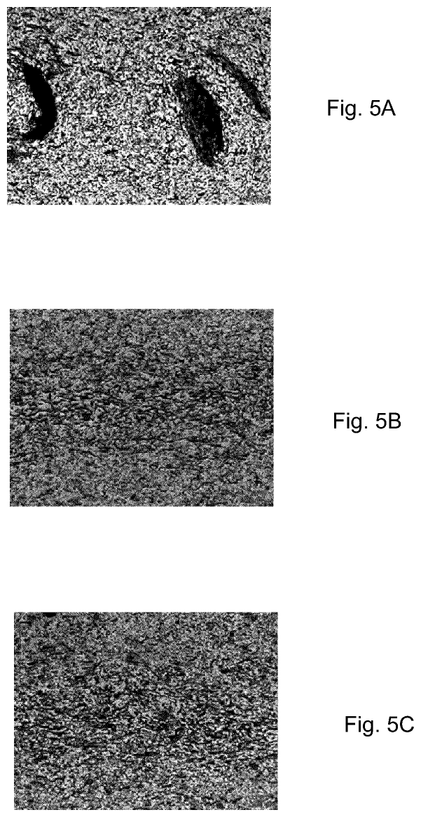

On the other hand, fibers treated with the AQ surfactant show very significant improvement of fiber dispersion in the PP matrix. The excellent fiber dispersion in the samples containing AQ treated fiber in comparison to the Benchmark sample was further confirmed by optical microscopic observations as shown in comparing FIG. 5A (Benchmark composite) to FIG. 5B (F1A1-based composite) and FIG. 5C (F1A3-based composite).

In other tests, the treated fiber samples were not affected by adding other additives, such as the processing aids (Struktol™) and low-cost filler (CaO), which are advantageous for industrial applications.

Tensile properties of standard type I dog-bone-shaped specimens of the composite samples in Table 2 were made by injection molding and tested according to ASTM D638. The results were shown in Table 3. The composites having fibers treated with AQ showed an increase in tensile strength of up to 10% with improved ductility (elongation at break) compared to the Benchmark sample using untreated chopped fiber.

TABLE 3
Tensile Properties

| | Tensile | Tensile | | Elongation | |
|---|---|---|---|---|---|
| | Strength | Modulus | | at Break | |
| Sample | (MPa) | (MPa) | | (%) | |
| PP6323 | 28.6 (0.3) | 1415 | (69) | 924 | (1) |
| Benchmark | 40.1 (1.1) | 3201 | (46) | 3.3 | (0.4) |
| 30F1A1E | 43.7 (0.2) | 3154 | (246) | 4.6 | (0.2) |
| 30F1A2E | 41.8 (0.5) | 3252 | (139) | 4.3 | (0.2) |
| 30F1A3E | 43.2 (1.3) | 3072 | (98) | 5.0 | (0.2) |

From this Example, it is evident that AQ fiber treatment can significantly improve fiber dispersion in the polymer composites, which ensures greater durability and facilitates use of the composite in thin wall applications, whereas the composites having non-treated fibers have are poor fiber dispersion with big aggregates, which are not acceptable for composite applications requiring good processability and surface quality. In addition, AQ fiber treatment improves mechanical properties of the polymer composite, such as the tensile strength by up to 10%. Also, AQ is an efficient surfactant, which can be used in an amount as low as 0.75 wt %, based on the weight of the treated fiber, to achieve polymer composites having good appearance, good fiber dispersion and good mechanical properties.

### Example 3: Validation of Fiber Treatment Using SS Surfactant in Batch Mechanical Mixer

Fiber treatment was performed as in Example 2, except that SS was used as the surfactant. A second batch of SS-treated fibers was prepared without centrifugation to remove water before drying. The two batches of SS-treated cellulose fibers are as follows:
Batch SS-1 (no centrifugation): has 3.5 wt % SS, based on weight of treated fiber.
Batch SS-2 (with centrifugation): has 3.5 wt % SS, based on weight of treated fiber.

The SS-treated Kraft pulp fibers were compounded with polypropylene (PP) (Pro-fax™ 6323) by the method described in Example 2 to provide composite formulations as shown in Table 4.

TABLE 4
Composite Formulations: SS-Treated Fibers

| | | Fiber | Epolene ™ |
|---|---|---|---|
| | | (wt % in | (wt % in |
| Sample Name | Fibre Type | composite) | composite) |
| Benchmark | Chopped Kraft fiber | 30 | 2 |
| PP1-SS1 | SS1 | 30 | 2 |
| PP1-SS2 | SS2 | 30 | 2 |
| PP1-SS1-MB | SS1 | 40 | 2.7 |

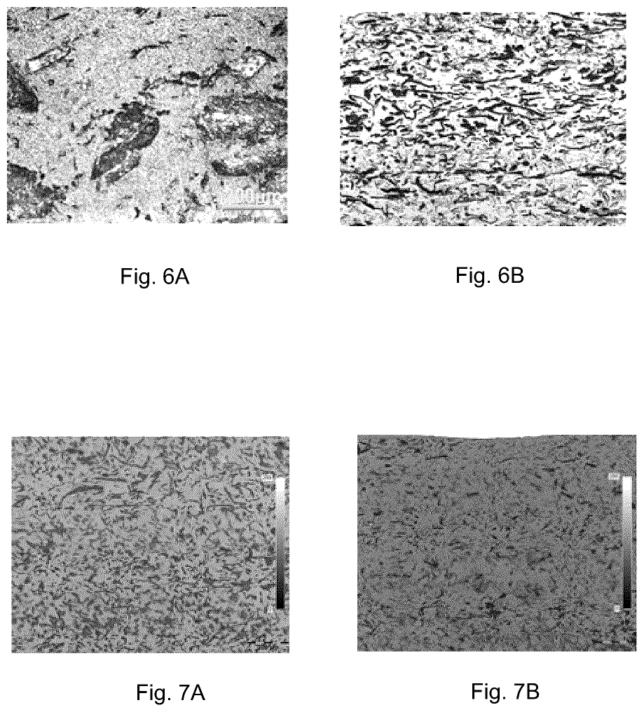

Standard type I dog-bone-shaped specimens of the composite samples in Table 4 were made by injection molding. The Masterbatch (PP1-SS1-MB) of SS-treated fiber composites were used directly for injection molding by dry mixing with pristine PP. Similar to the specimens made from AQ-treated fibers, the specimens made from SS-treated fibers provide significant improvement of fiber dispersion in the PP matrix. The excellent fiber dispersion of the SS-treated fibers over untreated chop fibers in the composites was further confirmed by optical microscopic observations as shown in FIG. 6A (Benchmark) and FIG. 6B (PP1-SS1).

Tensile properties of the dog-bone-shaped specimens of the composite samples in Table 4 were tested according to ASTM D638. The results were shown in Table 5. SS proved to be a good bio-based surfactant for cellulose fiber treatment and the treated fiber composites have improved fiber dispersion, tensile strength and ductility in comparison to the composites made from untreated cellulose fibers. Improvement in tensile strength was over 4%, improvement in tensile modulus was over 10%, and improvement in ductility was over 25%.

TABLE 5
Tensile Properties

| | Tensile | Tensile | | Elongation | |
|---|---|---|---|---|---|
| | Strength | Modulus | | at Break | |
| Sample | (MPa) | (MPa) | | (%) | |
| PP6323 | 28.6 (0.3) | 1415 | (69) | 924 | (1) |
| Benchmark | 39.2 (1.0) | 3238 | (86) | 6.4 | (0.7) |
| PP1-SS1 | 41.0 (0.8) | 3664 | (93) | 8.2 | (0.5) |
| PP1-SS2 | 43.7 (0.4) | 3639 | (131) | 8.5 | (0.1) |
| PP1-SS1-MB dilution | 39.4 (0.4) | 3427 | (141) | 7.8 | (0.6) |
| to 30% fiber | | | | | |

### Example 4: Synergistic Effect of Surfactant-Treated Cellulose Fiber with CaO

This Example demonstrates the synergistic effect of surfactant-treated cellulose fibers and CaO in a polymer composite.

Fiber treatments were performed as in Example 2 to provide surfactant-treated cellulose fibers as follows:
PP-TMP-Tide: Thermomechanical pulp fibers having 3.5 wt % Tide surfactant.
PP-Kraft-AQ: Kraft pulp fibers having 3.5 wt % AQ surfactant.

The surfactant-treated pulp fibers were compounded with two types of polypropylene, Pro-fax™ SG802N and Pro-fax 6323™, and with CaO to form polymer composites. In addition, 2 wt % Epolene™ E-43 compatibilizer and 2 wt % Struktol™ TPW 104 processing aid were included in the compounding. Compounding was performed as in Example 2. The samples were injection molded into standard type I dog-bone-shaped specimens as described in Example 2. Table 6 lists the samples that were compounded.

TABLE 6
Composite Formulations

| | | | Fiber | CaO | Epolene ™ |
|---|---|---|---|---|---|
| | | | (wt % in | (wt % in | (wt % in |
| Sample | Polymer | Fiber Type | composite) | composite) | composite) |
| PP1 | Pro-fax | | | | |
| | SG802N | | | | |
| PP-TMP- | Pro-fax | TMP | 30 | | 2 |
| Benchmark | SG802N | | | | |
| PP-TMP-CaO- | Pro-fax | TMP | 30 | 10 | 2 |
| Benchmark | SG802N | | | | |
| PP-TMP-Tide | Pro-fax | TMP-Tide | 30 | | 2 |
| | SG802N | | | | |
| PP-TMP-Tide-CaO | Pro-fax | TMP-Tide | 30 | 10 | 2 |
| | SG802N | | | | |
| PP2 | Pro-fax | | | | |
| | 6323 | | | | |
| PP-Kraft-AQ | Pro-fax | Kraft-AQ | 30 | | 2 |
| | 6323 | | | | |
| PP-Kraft-AQ-CaO | Pro-fax | Kraft-AQ | 30 | 5 | 2 |
| | 6323 | | | | |

Observation of the specimens showed that the surfactant-treated fibers always provide very significant improvement of fiber dispersion in the polymer matrix in comparison to untreated fibers. Adding CaO does not adversely affect the good fiber dispersion.

Tensile properties of the dog-bone-shaped specimens of the composite samples in Table 6 were tested according to ASTM D638. The results were shown in Table 7. Tensile strength of the polymer composite was improved with the inclusion of either one of the surfactant-treated fibers. Further, when CaO was included in the composite, the composite containing either one of the surfactant-treated fibers also exhibited significantly improved tensile strength and tensile modulus. The combination of surfactant-treated fibers and CaO provides a synergistic effect on the tensile properties of the polymer composite. This synergistic effect was not observed when CaO was added to the composites containing the non-treated fibers.

TABLE 7
Tensile Properties

| | Tensile | Tensile | Elongation | |
|---|---|---|---|---|
| | Strength | Modulus | at Break | |
| Sample | (MPa) | (GPa) | (%) | |
| PP Pro-fax SG802N | 20.0 (0.1) | 1.2 (0.0) | 38.2 | (12.3) |
| PP-TMP-Benchmark | 33.5 (0.1) | 2.9 (0.1) | 3.7 | (0.0) |
| PP-TMP-CaO-Benchmark | 30.7 (0.1) | 3.2 (0.0) | 3.9 | (0.1) |
| PP-TMP-Tide | 32.3 (1.3) | 3.1 (0.1) | 2.8 | (0.5) |
| PP-TMP-Tide-CaO | 42.4 (0.2) | 3.8 (0.1) | 3.2 | (0.1) |
| PP Pro-fax 6323 | 29.2 (0.2) | 1.5 (0.0) | No break | |
| PP-Kraft-AQ | 43.2 (1.3) | 3.1 (0.1) | 5.0 | (0.2) |
| PP-Kraft-AQ-CaO | 48.0 (0.5) | 3.7 (0.1) | 4.9 | (0.2) |

### Example 5: Fiber Composite Masterbatch Using Treated Fiber

This Example demonstrates the advantages of producing a fiber composite masterbatch (MB) using the treated cellulose fibers, in which the composite MB was used directly by dilution (dry mixing with pristine polymer) for injection molding applications.

Kraft pulp fiber treatments were performed as in Example 2 to provide surfactant-treated cellulose fibers as follows:
SS: has 2 wt % SS, based on weight of treated fiber

The SS-treated Kraft pulp fibers were compounded with polypropylene (PP) (Pro-fax™ 6323) by the method described in Example 2 to provide composite formulations composites with 25% fiber content and MB with 50% fiber content as shown in Table 8. Compounding was performed as in Example 2. The samples were injection molded into standard type I dog-bone-shaped specimens as described in Example 2. The composite MB pellets were diluted from 50 wt % fiber to 10-30 wt % fiber content by mixing with pristine PP, and were then directly used for injection molding without further compounding.

TABLE 8
Composite Formulations

| | | | | Struktol ™ |
|---|---|---|---|---|
| | | Fiber | Epolene ™ | TW104 |
| | | (wt % in | (wt % in | (wt % in |
| Sample | Fiber Type | composite) | composite) | composite) |
| PP 6323 | | | | |
| Benchmark | Chopped | 30 | 2 | 1.0 |
| | Kraft fiber | | | |
| PP-SS-25 | SS | 25 | 2 | 1.0 |
| PP-SS-MB-50 | SS | 50 | 3.3 | 1.7 |

Observation of the specimens shows that the specimen injection molded directly from MB dilution has excellent fiber dispersion, which is similar to those injection molded using the SS-treated fiber. The excellent fiber dispersion of the parts molded using SS MB dilution was further confirmed by optical microscopic observations as shown in FIG. 7A (PP-SS-25) and FIG. 7B (PP-SS-MB-50). Injection molded parts using MB pellets for automotive applications show good surface quality and fiber dispersion.

Tensile properties of the dog-bone-shaped specimens of the composite samples in Table 8 were tested according to ASTM D638. The results were shown in Table 9.

TABLE 9
Tensile Properties

| | Fiber | Tensile | Tensile | | |
|---|---|---|---|---|---|
| | (wt % in | Strength | Modulus | Elongation | |
| Sample | composite) | (MPa) | (GPa) | at Break (%) | |
| PP-6323 | | 27.5 (0.4) | 1.34 (0.04) | No break | |
| Benchmark | 30 | 32.4 (0.9) | 2.90 (0.10) | 3.9 | (0.4) |
| PP-SS-25 | 25 | 39.2 (0.5) | 2.96 (0.13) | 13.3 | (0.2) |
| PP-SS-MB- | 25 | 39.5 (0.7) | 2.93 (0.16) | 10.0 | (0.6) |
| Dilution | | | | | |
| (25% fibre) | | | | | |

The fiber composites masterbatch using the SS-treated fiber can used directly for injection molding applications by dry mixing with pristine polymers. The injection molded samples maintained good fiber dispersion and mechanical performance thanks to effectiveness of the treated fiber. The Masterbatch (MB) approach has significant advantages, such as avoiding an extra compounding step to make composites with lower fiber content, significantly reducing processing cost without further compounding, and reducing energy consumption and greenhouse gas (GHG) emissions.

### Example 6: Simulating a Continuous Fiber Treatment Process

In this Example, cellulose fiber treatment with AQ surfactant was simulated in a semi-continuous process to validate the effectiveness of the process in a continuous process. In a first option, the process described in connection with FIG. 3 was conducted. In a second option, the process described in connection with FIG. 4 was conducted.

Option 1 (A1 sample): Adding Surfactant to Pulp Suspension

Dried, shredded Kraft pulp was dispersed into tap water at room temperature to obtain a suspension of about 2 wt % pulp, based on total weight of the suspension. A solution of AQ surfactant (7 wt % based on total weight of the solution) was added to the pulp suspension to provide 3.5 wt % AQ based on the weight of the pulp. The treated pulp suspension was sprayed inside the centrifuge of a Noram Dynamic Sheet Former to form a wet sheet. The centrifuge was operated at 1312 rpm for 60 seconds to remove water. The wet sheet was removed from the centrifuge and compressed at 30 psi in a Noram Sheet Press to further remove water, and then the pressure was increased to 60 psi to continue removing water. The de-watered sheet was then dried.

### Option 2 (A2 Sample): Spraying Surfactant on Wet Sheet

Dried, shredded Kraft pulp was dispersed into tap water at room temperature to obtain a suspension of about 2 wt % pulp, based on total weight of the suspension. The pulp suspension was sprayed inside the centrifuge of a Noram Dynamic Sheet Former to form a wet sheet. The centrifuge was operated at 1312 rpm for 60 seconds to remove water. A solution of AQ surfactant (7 wt % based on total weight of the solution) was sprayed on to the wet sheet in the centrifuge to provide 3.5 wt % AQ based on the weight of the pulp. The centrifuge was operated again at 1312 rpm for 60 seconds to remove water. The wet sheet was removed from the centrifuge and compressed at 30 psi in a Noram Sheet Press to further remove water, and then the pressure was increased to 60 psi to continue removing water. The de-watered sheet was then dried.

The treated cellulose fibers obtained from Options 1 and 2 were compounded with polypropylene (Braskem™ FT200WV) to verify the effectiveness of the semi-continuous process in fiber treatment for PP/fiber composites, in terms of mechanical properties and fiber dispersion in the PP matrix. Compounding was carried out using two different twin screw extruders:
34 mm Leistritz™ TSE compounder, with a low throughput of 10 kg/hr and very aggressive screw configuration with the objective of breaking the fiber agglomerates in order to improve the good fiber dispersion;
34 mm Coperion™ TSE compounder, with a high throughput of 30 kg/hr and very gentle screw configuration with the objective of having high throughput to reduce energy consumption and thermal degradation and to maintain fiber length.

Composite formulations that were compounded were injection molded into standard type I dog-bone-shaped specimens as described in Example 2. Table 10 lists the composite formulations.

TABLE 10
Composite Formulations

| | | | Fiber | Epolene ™ |
|---|---|---|---|---|
| | | | (wt % in | (wt % in |
| Sample | Extruder | Fiber Type | composite) | composite) |
| Benchmark-Leistritz | Leistritz ™ | Chopped fibre | 30 | 2 |
| PP-A1-AQ-Leistritz | Leistritz ™ | A1-Fiber-AQ | 30 | 2 |
| PP-A2-AQ-Leistritz | Leistritz ™ | A2-Fiber-AQ | 30 | 2 |
| Benchmark-Coperion | Coperion ™ | Chopped Kraft | 30 | 2 |
| | | Fiber | | |
| PP-A1-AQ-Coperion | Coperion ™ | A1-Fiber-AQ | 30 | 2 |
| PP-A2-AQ-Coperion | Coperion ™ | A2-Fiber-AQ | 30 | 2 |

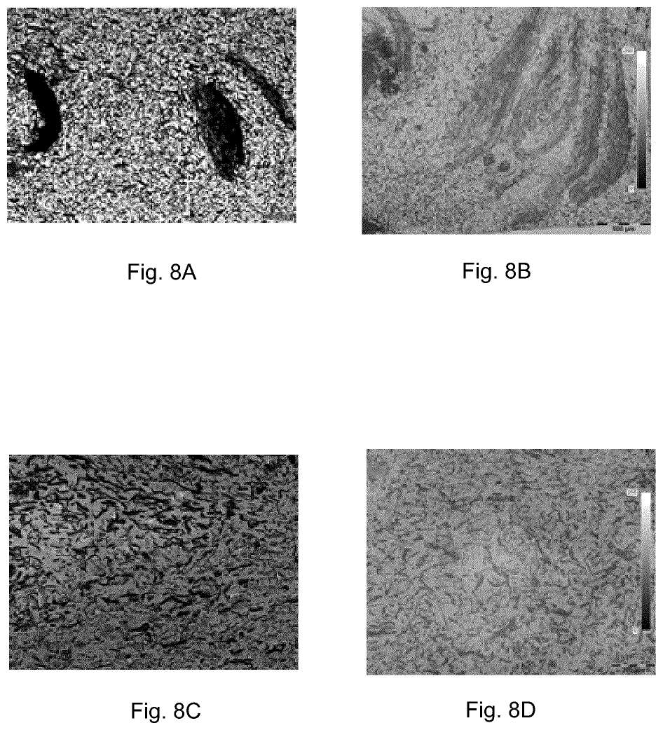

Observation of the specimens demonstrated that the AQ-treated fibers provide good quality PP composite parts even at high throughput and minimal shear (using Coperion™ extruder). However, for specimens comprising non-treated fibers, a much lower throughput and aggressive screw configuration (using Leistritz™ extruder) are required to get satisfactory part quality. Further, with reference to FIG. 8C and FIG. 8D, optical microscopy shows that PP composites in which the cellulose fibers are treated with AQ surfactant have good fiber dispersion even at high throughput and minimal shear (using the Coperion™ extruder, FIG. 8C). However, for PP composites having non-treated cellulose fiber, a much lower throughput and aggressive screw configuration is required to get satisfactory fiber dispersion (using Leistritz™ extruder, FIG. 8B) in comparison to using the Coperion™ extruder (FIG. 8A). The results demonstrate that the fiber treatment technology has significant advantages in terms of increased production efficiency due to the higher throughput, increased energy efficiency due to the less required mixing, and improved part quality due to better fiber dispersion.

Tensile properties of the dog-bone-shaped specimens of the composite samples in Table 10 were tested according to ASTM D638. The results are shown in Table 11.

TABLE 11
Tensile Properties

| | Tensile | Tensile | | Elongation | |
|---|---|---|---|---|---|
| | Strength | Modulus | | at Break | |
| Sample | (MPa) | (MPa) | | (%) | |
| PP- Braskem FT200WV | 35.3 (0.4) | 2535 | (38) | 10.2 | (0.3) |
| Benchmark-Leistritz | 40.5 (2.0) | 3600 | (113) | 6.8 | (0.7) |
| PP-A1-AQ-Leistritz | 42.7 (1.6) | 3271 | (162) | 10.5 | (0.3) |
| PP-A2-AQ-Leistritz | 46.6 (1.2) | 3373 | (174) | 10.4 | (1.0) |
| Benchmark-Coperion | 29.7 (4.0) | 3138 | (196) | 4.7 | (1.2) |
| PP-A1-AQ-Coperion | 46.4 (1.1) | 3713 | (139) | 7.2 | (0.7) |
| PP-A2-AQ-Coperion | 46.4 (1.9) | 3375 | (69) | 8.0 | (1.0) |

For the Benchmark composites, the one compounded using Coperion™ extruder showed significantly lower tensile properties, compared with the one compounded using the Leistritz™ extruder. The Leistritz™ extruder proved that for the non-treated fibers a very aggressive screw configuration is required to disperse the fibers into the polymer matrix in order to improve the mechanical properties of the composites. Accordingly, more energy will be consumed for compounding, and throughput of production will be limited.

In comparison, the surfactant-treated fiber composites showed similar mechanical properties regardless of the extruder used. The mechanical properties showed significant improvement in terms of the tensile strength and ductility compared to those of the untreated fiber composites. The surfactant-treated fibers were easy to disperse into the polymer matrix during compounding and thus require much less mixing by the screw elements. This will result in less energy consumption and higher throughput of production.

Further, the treatment method of Option 2 in which the fibers are sprayed with surfactant offers a less energy intensive alternative over Option 1 because there is less requirement for recycling or treating waste water.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A continuous process for treating cellulose particles, the process comprising:
continuously forming a cellulose pulp from a raw cellulose source in a pulp mill; and,
either
(a) mixing a bio-based surfactant with the pulp as the pulp is formed followed by continuously forming a surfactant-containing cellulose particle sheet from the pulp in the pulp mill,
(b) continuously forming a cellulose particle sheet from the pulp in the pulp mill followed by soaking the cellulose particle sheet as the sheet is formed with an aqueous solution of a bio-based surfactant to continuously form a surfactant-containing cellulose particle sheet, or
both steps (a) and (b),
the surfactant-containing cellulose particle sheet comprising 30-70 wt % of water, based on total weight of the surfactant-containing cellulose particle sheet.

2. (canceled)

3. (canceled)

4. The process of claim 1, wherein soaking the cellulose particle sheet comprises spraying the cellulose particle sheet with the aqueous solution of the bio-based surfactant by continuously passing the cellulose particle sheet past a sprayer that sprays the aqueous solution of the bio-based surfactant.

5. The process of claim 1, further comprising compressing the surfactant-containing cellulose particle sheet as the surfactant-containing cellulose particle sheet is formed to reduce water content in and remove excess surfactant from the surfactant-containing cellulose particle sheet.

6. The process of claim 5, further comprising drying the surfactant-containing cellulose particle sheet after compressing to further reduce the water content of the surfactant-containing cellulose particle sheet.

7. The process of claim 1, further comprising separating treated cellulose particles from the surfactant-containing cellulose particle sheet.

8. A process for treating cellulose particles, the process comprising:
(a) mixing a bio-based surfactant with the cellulose particles, or
(b) forming a cellulose particle sheet from cellulose particles followed by soaking the cellulose particle sheet with an aqueous solution of a bio-based surfactant to form a surfactant-containing cellulose particle sheet.

9. The process of claim 1, wherein the bio-based surfactant comprises an alkyl chain having at least 12 carbon atoms.

10. The process of claim 1, wherein the bio-based surfactant is a cationic or an anionic surfactant comprising an alkyl chain having 16-20 carbon atoms, or any mixture thereof.

11. The process of claim 1, wherein the bio-based surfactant is di(hydrogenated tallow)dimethylammonium chloride, di(hydrogenated tallow)dimethylammonium bromide, sodium stearate, hexadecyltrimethylammonium chloride, hexadecyltrimethylammonium bromide or any mixture thereof.

12. The process of claim 1, wherein the bio-based surfactant is mixed with the cellulose pulp in an amount of wt % or less, based on weight of the cellulose particles.

13. The process of claim 12, wherein the amount of the bio-based surfactant is 2 wt % or less, preferably 1 wt % or less.

14. (canceled)

15. The process of claim 1, wherein the cellulose particles are fibers.

16. Treated cellulose particles produced from the process as defined in claim 1.

17. A polymer composite comprising the treated cellulose particles of claim 16 dispersed in a polymer matrix.

18. The polymer composite of claim 17, wherein the polymer matrix comprises a thermoplastic polymer.

19. The polymer composite of claim 18, wherein the thermoplastic polymer comprises a polyolefin.

20. The composite of claim 17, further comprising an inorganic filler dispersed in the polymer matrix.

21. The polymer composite of claim 20, wherein the inorganic filler comprises magnesium oxide, calcium oxide, magnesium hydroxide, calcium hydroxide, magnesium carbonate, calcium carbonate or any mixture thereof.

22. The polymer composite of claim 20, wherein the inorganic filler comprises calcium oxide.

23. The polymer composite of claim 20, wherein the inorganic filler is present in an amount of 5-15 wt %, based on total weight of the composite.
